(19) United States
(12) Patent Application Publication
(10) Pub. No.: US 2016/0380302 A1
(43) Pub. Date: Dec. 29, 2016

(54) CURVED SECONDARY BATTERY AND MANUFACTURING METHOD THEREOF

(71) Applicant: SAMSUNG SDI CO., LTD., Yongin-si (KR)

(72) Inventor: Youngkwang YUN, Yongin-si (KR)

(21) Appl. No.: 14/943,047

(22) Filed: Nov. 17, 2015

(30) Foreign Application Priority Data
Jun. 26, 2015 (KR) 10-2015-0091228

(51) Int. Cl. H01M 10/058; H01M 2/02; H01M 10/04

(52) U.S. Cl. CPC H01M 10/058; H01M 10/0431; H01M 10/049; H01M 2/0202; H01M 2002/0205; H01M 2220/30

(57) ABSTRACT

A manufacturing method of a curved secondary battery includes fabricating an electrode assembly such that the electrode assembly includes a first electrode plate having a first electrode tab, a second electrode plate having a second electrode tab, and a separator interposed between the first electrode plate and the second electrode plate, inserting the electrode assembly into a pouch and injecting a liquid-type gel electrolyte to form a basic secondary battery, wherein the first electrode tab and the second electrode tab protrude from the pouch in a direction, carrying out a first molding to form a curved secondary battery having a curvature, the first molding including placing the basic secondary battery in a jig and pressing, and carrying out a second molding to gel the liquid-type gel electrolyte, the second molding including heating the curved secondary battery in a state in which the curved secondary battery is pressed by the jig.

### CROSS-REFERENCE TO RELATED APPLICATION

Korean Patent Application No. 10-2015-0091228, filed on Jun. 26, 2015, in the Korean Intellectual Property Office, and entitled: “Curved Secondary Battery and Manufacturing Method Thereof,” is incorporated by reference herein in its entirety.

### BACKGROUND

1. Field

Embodiments relate to a curved secondary battery and a manufacturing method thereof.

2. Description of the Related Art

Unlike primary batteries which are not rechargeable, secondary batteries can be charged and discharged. Low-capacity secondary batteries each using a single battery cell packaged in a battery pack are widely employed in small-sized electronic devices such as cellular phones or camcorders, while large-capacity secondary batteries each using tens of battery cells connected to each other in a battery pack are typically used for driving motors of hybrid automobiles or the like.

Recently, to cope with customers' demand, designs of electronic devices have been diversified from conventional electronic devices having flat designs typically used from a standpoint of manufacturability.

### SUMMARY

Embodiments are directed to a manufacturing method of a curved secondary battery including fabricating an electrode assembly such that the electrode assembly includes a first electrode plate having a first electrode tab, a second electrode plate having a second electrode tab, and a separator interposed between the first electrode plate and the second electrode plate, inserting the electrode assembly into a pouch and injecting a liquid-type gel electrolyte to form a basic secondary battery, wherein the first electrode tab and the second electrode tab protrude from the pouch in a direction, carrying out a first molding to form a curved secondary battery having a curvature, the first molding including placing the basic secondary battery in a jig and pressing, and carrying out a second molding to gel the liquid-type gel electrolyte, the second molding including heating the curved secondary battery in a state in which the curved secondary battery is pressed by the jig.

The jig may include a lower jig having a convex portion having a curvature and an upper jig having a concave portion corresponding to the convex portion. In the first molding, the basic secondary battery may be placed on the convex portion of the lower jig and then pressed by the upper jig.

In the first molding, the basic secondary battery may be curved so as to have a same curvature as the convex portion.

In the first molding, the basic secondary battery may be placed such that an axis parallel to direction in which the first and second electrode tabs protrude from the pouch comes into contact with the convex portion. The basic secondary battery may be curved in a direction in which opposite ends of the basic secondary battery come closer to each other on the basis of the axis parallel to the direction in which the first and second electrode tabs protrude from the pouch.

In the first molding, the basic secondary battery may be placed such that an axis perpendicular to a direction in which the first and second electrode tabs protrude from the pouch comes into contact with the convex portion. The basic secondary battery may be curved in a direction in which opposite ends of the basic secondary battery come closer to each other on the basis of the axis perpendicular to the direction in which the first and second electrode tabs protrude from the pouch.

The manufacturing method may further include, after the injecting of the electrolyte, removing gases in the basic secondary battery and folding sealing portions of the pouch.

The pouch may include a lower pouch layer having an accommodating groove and an upper pouch layer covering the lower pouch layer. The curved secondary battery may be curved such that the lower pouch layer is convexly curved.

Embodiments are also directed to a curved secondary battery including an electrode assembly including a stacked or wound structure, the stacked or wound structure including a first electrode plate having a first electrode tab, a second electrode plate having a second electrode tab, and a separator interposed between the first electrode plate and the second electrode plate, a pouch accommodating the electrode assembly, wherein the first electrode tab and the second electrode tab protrude outside the pouch, the pouch includes a gel electrolyte therein, and the electrode assembly and the pouch have a curvature.

The curved secondary battery may be curved in a direction in which opposite ends thereof are closer to each other on the basis of an axis parallel to a direction in which the first and second electrode tabs protrude from the pouch, as compared to an uncurved state.

The curved secondary battery may be curved in a direction in which opposite ends thereof are closer to each other on the basis of an axis perpendicular to a direction in which the first and second electrode tabs protrude from the pouch, as compared to an uncurved state.

### BRIEF DESCRIPTION OF THE DRAWINGS

Features will become apparent to those of skill in the art by describing in detail exemplary embodiments with reference to the attached drawings in which:

FIG. 1 illustrates a flowchart of a manufacturing method of a curved secondary battery according to an embodiment;

FIGS. 2A to 2G illustrate diagrams depicting process steps of a manufacturing method of a curved secondary battery according to an embodiment; and

FIGS. 3A to 3D illustrate diagrams depicting stages of a manufacturing method of a curved secondary battery according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

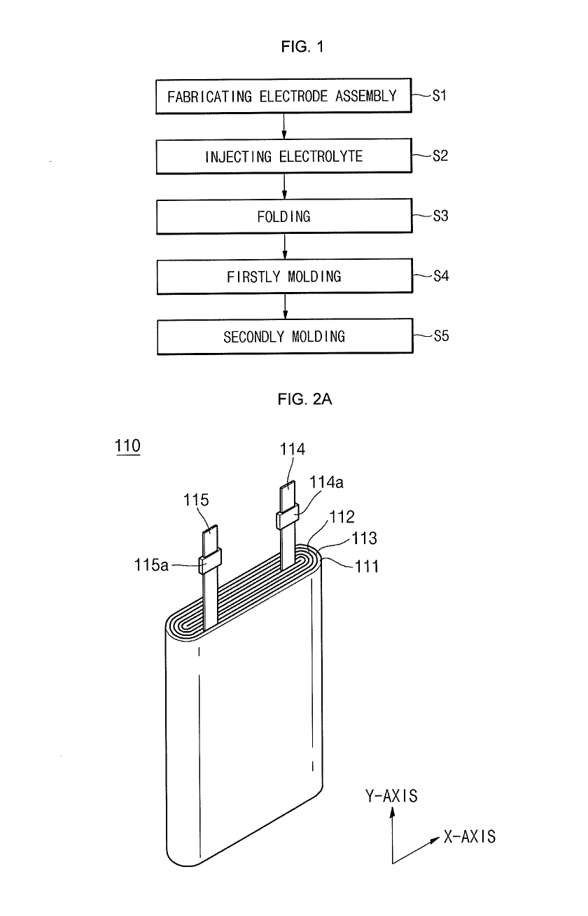

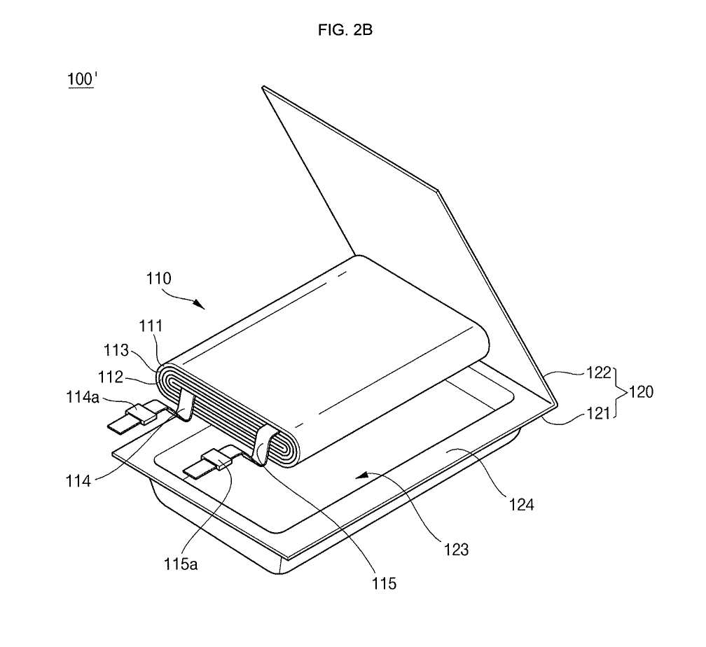

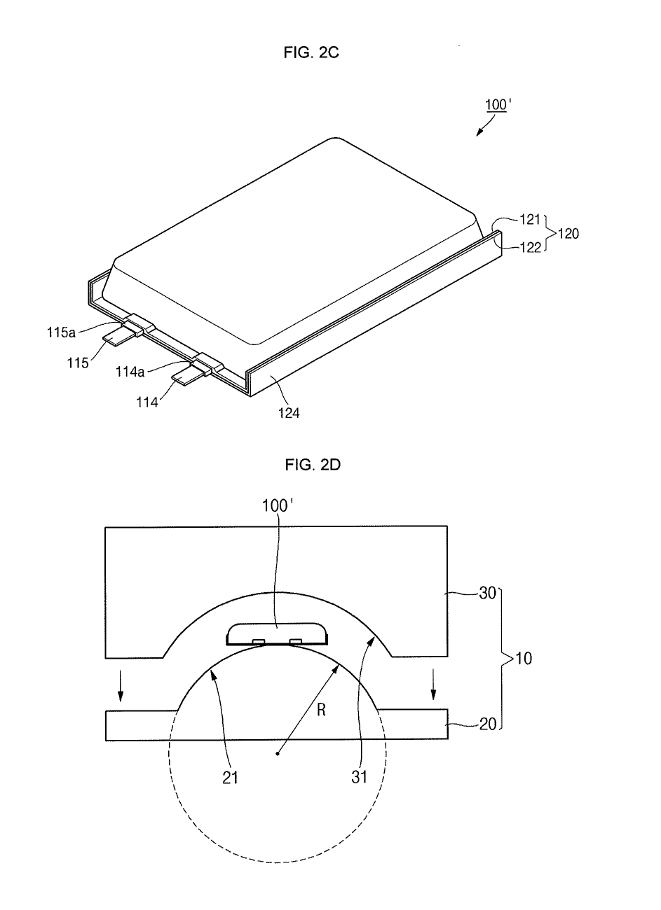

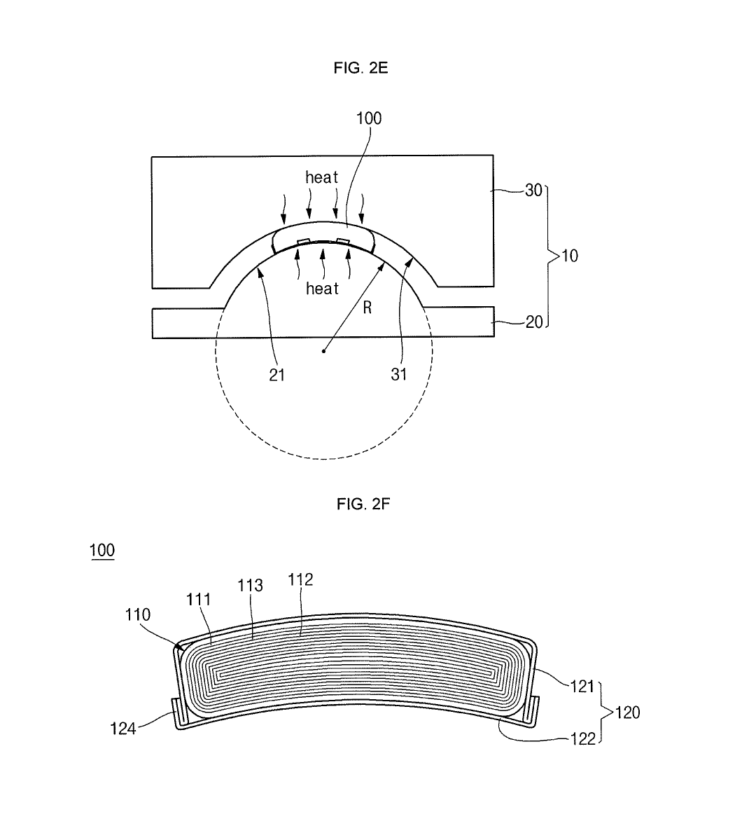

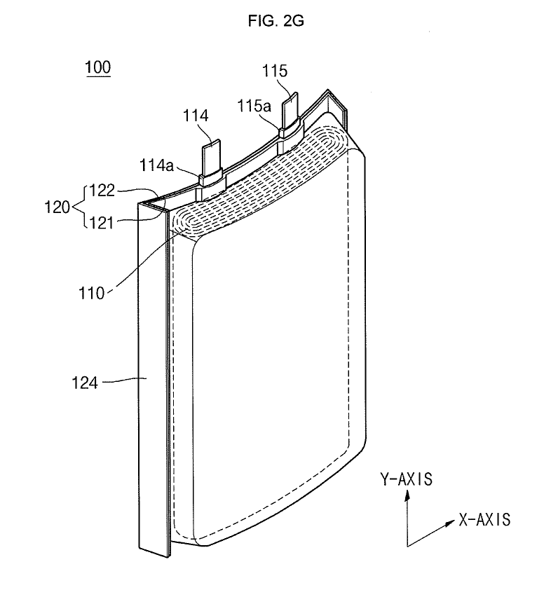

FIG. 1 illustrates a flowchart of a manufacturing method of a curved secondary battery according to an embodiment and FIGS. 2A to 2G illustrate diagrams depicting stages of a manufacturing method of a curved secondary battery according to an embodiment.

Referring to FIG. 1, the manufacturing method of a curved secondary battery according to an embodiment may include fabricating an electrode assembly (S1), injecting an electrolyte (S2), folding (S3), firstly molding (S4) and secondly molding (S5).

In the fabricating of the electrode assembly (S1), an electrode assembly 110 including a first electrode plate 111, a second electrode plate 112 and a separator 113, may be fabricated.

Referring to FIG. 2A, in the fabricating of the electrode assembly (S1), a stacked structure including the first electrode plate 111, the second electrode plate 112 and the separator 113 interposed between the first electrode plate 111 and the second electrode plate 112, may be wound in a jelly roll type, thereby fabricating the electrode assembly 100.

The first electrode plate 111 may be formed by coating a first active material, such as a transition metal oxide, on a first electrode current formed of a metal foil, such as an aluminum foil. A first electrode tab 114 may be attached to the first electrode plate 111. One end of the first electrode tab 114 may be electrically connected to the first electrode plate 111 and the other end of the first electrode tab 114 may protrude upwardly from the electrode assembly 110. An insulation member 114a may be attached to the first electrode tab 114. The insulation member 114a may help to prevent an electric short from being caused between a pouch 120 to be described below and the first electrode tab 114.

The second electrode plate 112 may be formed by coating a second active material, such as graphite or carbon, on a second electrode current formed of a metal foil, such as a copper or nickel foil. A second electrode tab 115 may be attached to the second electrode plate 112. One end of the second electrode tab 115 may be electrically connected to the second electrode plate 112 and the other end of the second electrode tab 115 may protrude upwardly from the electrode assembly 110. An insulation member 115a may be attached to the second electrode tab 115. The insulation member 115 may help to prevent an electric short from being caused between the pouch 120 to be described below and the second electrode tab 115.

The separator 113, positioned between the first electrode plate 111 and the second electrode plate 112, may help to prevent an electric short from being caused therebetween and may allow lithium ions to move. The separator 113 may be made of polyethylene, polypropylene, or a composite film of polyethylene and polypropylene.

In the injecting of the electrolyte (S2), the electrode assembly 110 may be inserted into the pouch 120, and an electrolyte may be injected.

Referring to FIG. 2B, in the injecting of the electrolyte (S2), the electrode assembly 110 may be first inserted into the pouch 120 including a lower pouch layer 121 and an upper pouch layer 122. The pouch 120 may be defined by a lower pouch layer 121 and an upper pouch layer 122 by folding one side of an integrally formed rectangular pouch layer in half in a lengthwise direction. In some implementations, the lower pouch layer 121 may include an accommodating groove 123 formed by, for example, a pressing process, to accommodate the electrode assembly 110 and sealing portions 124 to be sealed with the upper pouch layer 122. In the injecting of the electrolyte (S2), the electrode assembly 110 may be inserted into the accommodating groove 123. The first electrode tab 114 and the second electrode tab 115 may protrude to the outside of the pouch 120 through the sealing portions 124. The insulation members 114a and 115a attached to the first and second electrode tabs 114 and 115 may be positioned in the sealing portions 124, thereby helping to prevent an electric short from being caused between each of the first and second electrode tabs 114 and 115 and the pouch 120.

Next, an electrolyte is injected into the accommodating groove 123 of the pouch 120 having the electrode assembly 110 inserted thereinto. The electrolyte may be a gel electrolyte. The gel electrolyte may exist in a liquid state at room temperature and may be gelled to turn into a gel state by heating. For example, in the injecting of the electrolyte (S2), the liquid-type gel electrolyte may be injected. As described above, if the liquid-type gel electrolyte is injected into the pouch 120, the secondary battery having a desired shape may be manufactured.

The liquid-type gel electrolyte may include a nonaqueous organic solvent, a lithium salt, a monomer and an initiator. The monomer may be contained in an amount of about 4% to about 8% based on the total weight of the gel electrolyte. The monomer may include a first monomer represented by the following Chemical Formula 1 and a second monomer represented by the following Chemical Formula 2:

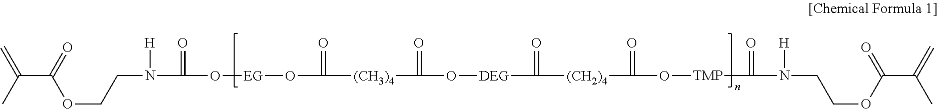

where n is in a range of 1,000 to 1,000,000, EG is ethylene glycol, DEG is diethylene glycol, and TMP is trimethyl phosphate.

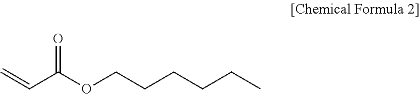

The initiator may include a peroxide-based initiator, for example, a peroxide-based initiator represented by the following Chemical Formula 3:

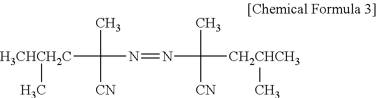

Next, the lower pouch layer 121 with the electrode assembly 110 and the gel electrolyte inserted thereinto may be covered by the upper pouch layer 122 and the sealing portions 124 may be pressed to seal the pouch 120, thereby completing a basic secondary battery 100′.

In the folding (S3), gases in the basic secondary battery 100′ may be removed and the sealing portions 124 of the pouch 120 may be folded.

In the folding (S3), the gases contained in the basic secondary battery 100′ may be removed by a degassing process. The degassing process may be performed to remove the internal gases of the basic secondary battery 100′ by pressing the basic secondary battery 100′.

Referring to FIG. 2C, in the folding (S3), the sealing portions 124 positioned on opposite side surfaces of the pouch 120, from which the first and second electrode tabs 114 and 115 do not protrude, may be curved to come into close contact with the accommodating groove 123.

In the first molding (S4), the basic secondary battery 100′ may be placed into the jig 10 and then pressed, thereby forming the curved secondary battery 100.

Referring to FIG. 2D, in the first molding (S4), a jig 10 including a lower jig 20 and an upper jig 30 may be provided, the basic secondary battery 100′ may be placed in the lower jig 20, and the basic secondary battery 100′ may then be pressed by the upper jig 30. The jig 10 may be made of a metal. The lower jig 20 may have a convex portion 21 having a curvature radius R, and the upper jig 30 may have a concave portion 31 corresponding to the convex portion 21. The concave portion 31 of the upper jig 30 may be formed to have a same curvature radius R as the convex portion 21. For example, the convex portion 21 and the concave portion 31 may have the same curvature. In some implementations, a plurality of basic secondary batteries 100′ may be inserted into the jig 30 to then be pressed at the same time. Here, when a liquid-type gel electrolyte is injected into the basic secondary battery 100′, the basic secondary battery 100′ may be transformed according to the pressing by the jig 10.

In the first molding (S4), the basic secondary battery 100′ may be placed in the convex portion 21 of the lower jig 20 and may be then pressed by the concave portion 31 of the upper jig 30. The basic secondary battery 100′ may be placed in the convex portion 21 of the lower jig 20 to bring the upper pouch layer 122 into contact with the convex portion 21 of the lower jig 20. The basic secondary battery 100′ may be placed in the convex portion 21 such that the Y axis parallel to a direction in which the first and second electrode tabs 114 and 115 protrude comes into contact with the convex portion 21. Then, as the basic secondary battery 100′ is pressed by the upper jig 30, opposite sides of the basic secondary battery 100′ may be curved on the basis of the Y axis (see FIG. 2E). When the upper pouch layer 122 of the basic secondary battery 100′ is in contact with the convex portion 21, the lower pouch layer 121 may be convexly curved. In addition, the electrode assembly 110 positioned within the pouch 120 may also be curved, like the pouch 120. Here, the lower pouch layer 121 of the basic secondary battery 100′ may be positioned to come into contact with the convex portion 21 of the lower jig 20, thereby allowing the upper pouch layer 122 to be convexly curved.

The basic secondary battery 100′ may be formed to turn into the curved secondary battery 100 having the same curvature with the convex portion 21 and the concave portion 31 (see FIG. 2E). For example, the curved secondary battery 100 may have a curvature of 44R and the convex portion 21 and the concave portion 31 also may have a curvature of 44R. The curvature of the curved secondary battery 100 may be adjusted as desired by a user by adjusting the curvature of the jig 10.

In the first molding (S4), the jig 10 may press the basic secondary battery 100′ with a pressure in a range of 1 kgF/cm² to 5kgF/cm² for 3 to 30 seconds, thereby forming the curved secondary battery 100. As described above, when the gel electrolyte is a soft liquid type electrolyte, the gel electrolyte may be pressed by the jig 10 and the shape of a secondary battery may be molded, thereby increasing the degree of freedom in the shape of the secondary battery.

In the second molding (S5), the curved secondary battery 100 may be heated to gel the liquid-type gel electrolyte.

As illustrated in FIG. 2E, in the second molding (S5), the curved secondary battery 100 curved by the jig 10 in the first molding (S4) may be heated at a high temperature, thereby gelling the liquid-type gel electrolyte. If the liquid-type gel electrolyte is heated at a high temperature, the liquid-type gel electrolyte is gelled to thus undergo volumetric expansion. The second molding (S5) may be performed in a state in which the basic secondary battery 100′ is pressed by the jig 10 to then be curved. The curved secondary battery 100 may be manufactured to have the same shape as the jig 10 while the pressed shape of the curved secondary battery 100 is maintained. The curved secondary battery 100 may be manufactured to have the same curvature as the jig 10 in a uniform shape. Accordingly, structural stability of the curved secondary battery 100 may be secured and the shape of the curved secondary battery 100 may be be maintained even after being charged and discharged for a long time and under severe surrounding conditions. In an Example, the curved secondary battery 100 was repeatedly charged and discharged for about 500 cycles. When the state of the curved secondary battery 100 after the 500 cycles of charging and discharging was compared to its initial state, only 3% or less of a change in the shape of the curved secondary battery 100 was observed. A spring back phenomenon or a return of the curved secondary battery 100 to its original flat basic secondary battery 100′ was not observed.

In the second molding (S5), the curved secondary battery 100 may be heated at a temperature of about 70° C. to about 90° C. for about 1 to 5 hours, thereby gelling the liquid-type gel electrolyte. In some implementations, the first molding (S4) and the second molding (S5) may be simultaneously performed.

Accordingly, as illustrated in FIGS. 2F and 2G, the curved secondary battery 100 according to an embodiment may be completed. The curved secondary battery 100 may include an electrode assembly 110, a pouch 120 accommodating the electrode assembly 110, a gel electrolyte injected into the pouch 120, and electrode tabs 114 and 115 electrically connected to the electrode assembly 110 and protruding to the outside of the pouch 120. The electrode assembly 110 and the pouch 120 may be curved to have a curvature. The curved secondary battery 100 may be curved such that opposite ends thereof come into closer contact with each other on the basis of a direction in which the electrode tabs 114 and 115 protrude (for example, on the basis of the Y axis). The curved secondary battery 100 may be curved such that the sealing portions 124 of opposite side surfaces of the curved secondary battery 100, from which the first and second electrode tabs 114 and 115 do not protrude, may be curved to come into closer contact with each other.

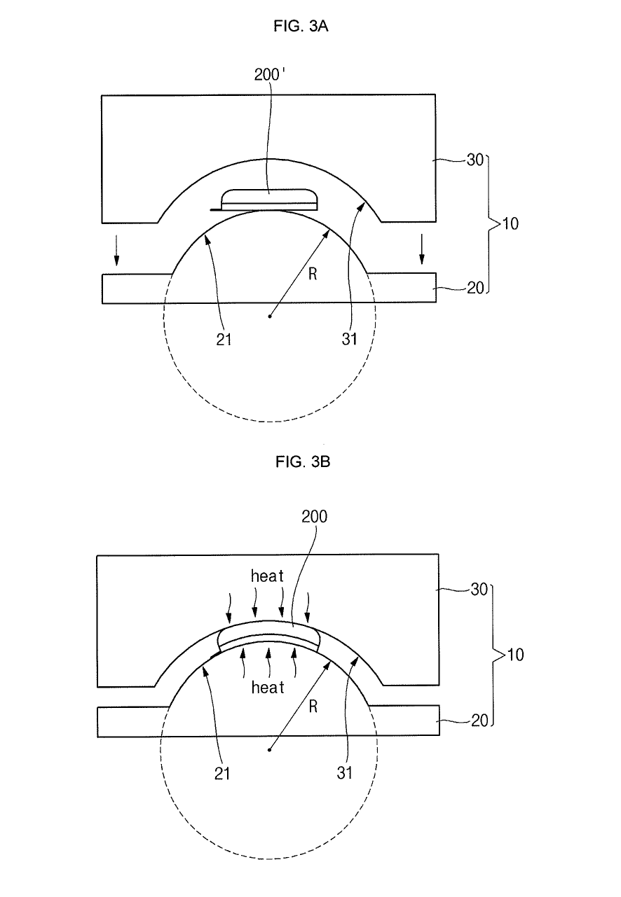

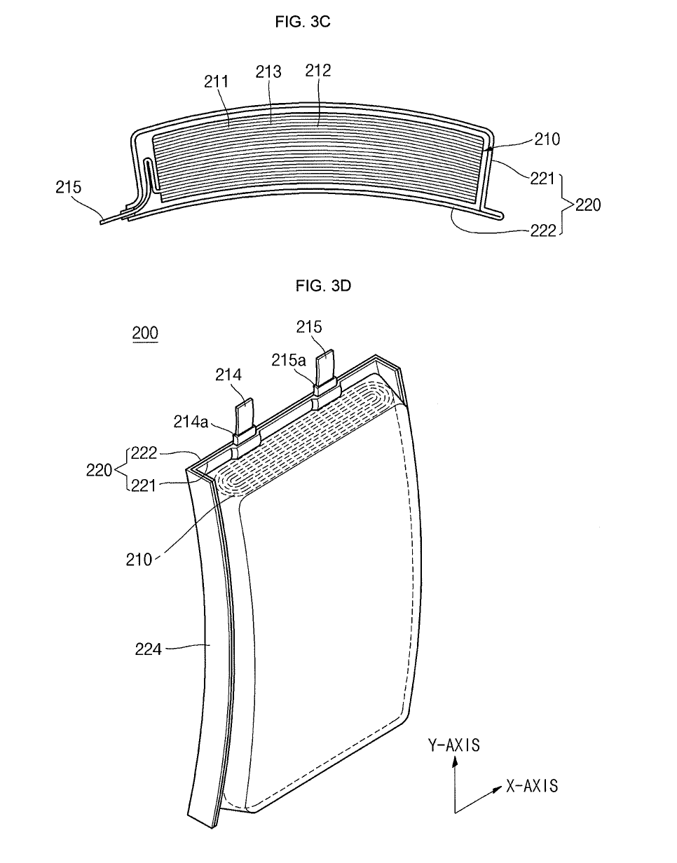

FIGS. 3A to 3D illustrate diagrams depicting stages of a manufacturing method of a curved secondary battery according to an embodiment.

The manufacturing method of a curved secondary battery according to this embodiment is similar to the manufacturing method of the curved secondary battery illustrated in FIGS. 2A to 2G, and the following description will focus only on differences between the manufacturing methods according to the present and previous embodiments.

Referring to FIG. 3A, in the first molding (S4) a basic secondary battery 200′ may be placed in a convex portion 21 of a lower jig 20 and may be then pressed by a concave portion 31 of an upper jig 30. The basic secondary battery 200′ may be placed in the convex portion 21 of the lower jig 20 to bring an upper pouch layer 222 into contact with the convex portion 21 of the lower jig 20. In this embodiment, the basic secondary battery 200′ may be placed in the convex portion 21 such that the X axis perpendicular to a direction in which first and second electrode tabs 214 and 215 protrude comes into contact with the convex portion 21.

As the basic secondary battery 200′ is pressed by the upper jig 30, opposite sides of the basic secondary battery 200′ may be curved on the basis of the X axis (see FIG. 3B). In addition, an upper pouch layer 222 of the basic secondary battery 100′ may be in contact with the convex portion 21. Accordingly, a lower pouch layer 221 may be convexly curved. In addition, when the upper pouch layer 222 of the basic secondary battery 200′ is in contact with the convex portion 21, the lower pouch layer 221 may be convexly curved. An electrode assembly 210 positioned within a pouch 220 may also be curved, like the pouch 220. Here, the lower pouch layer 221 of the basic secondary battery 200′ may be positioned to come into contact with the convex portion 21 of the lower jig 20, thereby allowing the upper pouch layer 222 to be convexly curved. The basic secondary battery 200′ may be formed to turn into the curved secondary battery 200 having the same curvature as the convex portion 21 and the concave portion 31 (see FIG. 3B).

As illustrated in FIG. 3B, in the second molding (S5), the curved secondary battery 200 curved by the jig 10 in the first molding (S4) may be heated at a high temperature, thereby gelling the liquid-type gel electrolyte. When the liquid-type gel electrolyte is heated at a high temperature, the liquid-type gel electrolyte may be gelled to thus undergo volumetric expansion. The second molding (S5) is performed in a state in which the basic secondary battery 200′ is pressed by the jig 10 to then be curved. The curved secondary battery 200 may be manufactured to have the same shape as the jig 10 while the pressed shape of the curved secondary battery 200 may be maintained. The curved secondary battery 200 may be manufactured to have the same curvature with the jig 10 in a uniform shape.

As illustrated in FIGS. 3C and 3D, the curved secondary battery 200 according to this embodiment may be completed. The curved secondary battery 200 may include the electrode assembly 210 including a first electrode plate 211, a second electrode plate 212 and a separator 213 interposed between the first electrode plate 211 and the second electrode plate 212, the pouch 220 accommodating the electrode assembly 210 and including the lower pouch layer 221 and the upper pouch layer 222, a gel electrolyte injected into the pouch 220, and the first and second electrode tabs 214 and 215 electrically connected to the electrode assembly 210 and protruding to the outside of the pouch 220. The electrode assembly 210 and the pouch 220 may be curved to have a curvature. Insulation members 214a and 215a may be attached to the first and second electrode tabs 214 and 215 and may help to prevent an electric short from being caused between the pouch 220 and each of the first and second electrode tabs 214 and 215. The lower pouch layer 221 may include sealing portions 224 to be sealed with the upper pouch layer 222. The curved secondary battery 200 may be curved such that opposite ends thereof come into closer contact with each other on the basis of a direction perpendicular to the direction in which the electrode tabs 214 and 215 protrude (for example, on the basis of the X axis). The curved secondary battery 200 may be curved such that portions from which the electrode tabs 214 and 215 protrude and a bent portion of the pouch 220 come into closer contact with each other.

By way of summation and review, electronic devices, such as mobile phones and laptop computers, have been designed to have curved surfaces for ergonomic purposes. Therefore, in order to minimize waste of space, it is desirable to design secondary batteries employed to electronic devices so as to have curved surfaces according to the designs of the electronic devices.

Embodiments provide a curved secondary battery, which can improve structural stability, and a manufacturing method thereof. In the curved secondary battery the manufacturing method thereof according to embodiments, the shape of a secondary battery is molded by pressing a gel electrolyte by a jig when the gel electrolyte is a soft liquid-type electrolyte and gelling the pressed gel electrolyte in a state in which the gel electrolyte is placed in the jig, thereby improving structural stability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A manufacturing method of a curved secondary battery, the method comprising:
fabricating an electrode assembly such that the electrode assembly includes a first electrode plate having a first electrode tab, a second electrode plate having a second electrode tab, and a separator interposed between the first electrode plate and the second electrode plate;
inserting the electrode assembly into a pouch and injecting a liquid-type gel electrolyte to form a basic secondary battery, wherein the first electrode tab and the second electrode tab protrude from the pouch in a direction;
carrying out a first molding to form a curved secondary battery having a curvature, the first molding including placing the basic secondary battery in a jig and pressing; and
carrying out a second molding to gel the liquid-type gel electrolyte, the second molding including heating the curved secondary battery in a state in which the curved secondary battery is pressed by the jig.

2. The manufacturing method as claimed in claim 1, wherein:
the jig includes a lower jig having a convex portion having a curvature and an upper jig having a concave portion corresponding to the convex portion, and
in the first molding, the basic secondary battery is placed on the convex portion of the lower jig and then pressed by the upper jig.

3. The manufacturing method as claimed in claim 2, wherein in the first molding, the basic secondary battery is curved so as to have a same curvature as the convex portion.

4. The manufacturing method as claimed in claim 2, wherein, in the first molding,
the basic secondary battery is placed such that an axis parallel to the direction in which the first and second electrode tabs protrude from the pouch comes into contact with the convex portion, and
the basic secondary battery is curved in a direction in which opposite ends of the basic secondary battery come closer to each other on the basis of the axis parallel to the direction in which the first and second electrode tabs protrude from the pouch.

5. The manufacturing method as claimed in claim 2, wherein, in the first molding,
the basic secondary battery is placed such that an axis perpendicular to a direction in which the first and second electrode tabs protrude from the pouch comes into contact with the convex portion, and
the basic secondary battery is curved in a direction in which opposite ends of the basic secondary battery come closer to each other on the basis of the axis perpendicular to the direction in which the first and second electrode tabs protrude from the pouch.

6. The manufacturing method as claimed in claim 1, further comprising, after the injecting of the electrolyte, removing gases in the basic secondary battery and folding sealing portions of the pouch.

7. The manufacturing method as claimed in claim 1, wherein
the pouch includes a lower pouch layer having an accommodating groove and an upper pouch layer covering the lower pouch layer, and
the curved secondary battery is curved such that the lower pouch layer is convexly curved.

8. A curved secondary battery, comprising:
an electrode assembly including a stacked or wound structure, the stacked or wound structure including a first electrode plate having a first electrode tab, a second electrode plate having a second electrode tab, and a separator interposed between the first electrode plate and the second electrode plate;
a pouch accommodating the electrode assembly, wherein:
the first electrode tab and the second electrode tab protrude outside the pouch;
the pouch includes a gel electrolyte therein,
the electrode assembly and the pouch have a curvature.

9. The curved secondary battery as claimed in claim 8, wherein the curved secondary battery is curved in a direction in which opposite ends thereof are closer to each other on the basis of an axis parallel to a direction in which the first and second electrode tabs protrude from the pouch, as compared to an uncurved state.

10. The curved secondary battery as claimed in claim 8, wherein the curved secondary battery is curved in a direction in which opposite ends thereof are closer to each other on the basis of an axis perpendicular to a direction in which the first and second electrode tabs protrude from the pouch, as compared to an uncurved state.
